(19) United States
(12) Patent Application Publication
(10) Pub. No.: US 2018/0304192 A1
(43) Pub. Date: Oct. 25, 2018

(54) COLUMN FOR EXCHANGING HEAT AND/OR MATERIAL BETWEEN TWO FLUIDS COMPRISING A COLLECTOR TRAY AND GAS MIXING MEANS

(71) Applicants: TOTAL SA, Courbevoie (FR); PROSERNAT, Rueil-Malmaison (FR); IFP Energies Nouvelles, Rueil-Malmaison Cedex (FR)

(72) Inventors: Gauthier PERDU, Suresnes (FR); Clement SALAIS, Paris (FR); Vincent CARLIER, Lyon (FR); Claire WEISS, Vaucresson (FR); Thomas MAUBERT, Paris (FR); Maxime FOURNIE, Paris (FR); Manel FOURATI, Lyon (FR); Pascal ALIX, Roussillon (FR); Philippe BEARD, Saint Genis-Laval (FR)

(73) Assignees: TOTAL SA, Courbevoie (FR); PROSERNAT, Rueil-Malmaison (FR); IFP Energies Nouvelles, Rueil-Malmaison Cedex (FR)

(21) Appl. No.: 15/771,452

(22) PCT Filed: Oct. 30, 2015
(86) PCT No.: PCT/FR2015/052931

§ 371 Date: Apr. 27, 2018

(51) Int. Cl. B01D 53/18; B01D 3/26; B01D 3/32; B01D 3/00; B01D 53/14; B01J 19/32

(52) U.S. Cl. CPC B01D 53/185; B01D 3/26; B01D 3/32; B01D 2252/204; B01D 53/1475; B01J 19/32; B01D 3/008

(57) ABSTRACT

The present invention relates to a column for exchanging heat and/or material between a gas and a liquid. The column comprises at least one collector tray (1), at least one packed bed, and mixing means for a gas flow (7, 8). According to the invention, the mixing means for a gas flow are arranged below the collector tray (1) and above the packing.

The present invention relates to the field of liquid-gas contacting columns, and more particularly the gas treatment, CO₂ capture, dehydration or even distillation offshore columns (at sea).

The gas treatment and/or CO₂ capture units based on amine washing comprise absorption and regeneration columns for fluids, liquid or gases. The latter operate under counter-current or co-current liquid-gas flow conditions. When they are offshore, the columns can be installed on vessels, floating barges or offshore platforms, for example of FPSO (Floating Production, Storage and Offloading) type or of FLNG (Floating Liquefied Natural Gas) type. On the floating barges, distillation columns or dehydration columns can also be installed.

The columns used in these gas treatment and/or CO₂ capture and/or distillation and/or dehydration units (offshore or on land) generally operate on the principle of an exchange of material and/or of heat between the gas and the fluid which circulate in the columns. Conventionally, this gas treatment column comprises a number of sections, each section comprising a contactor (also called packing), and a collector tray, which is arranged above the contactor. The gas/liquid contactor contacts the gas and the liquid in order to allow the exchanges of heat and/or of material. The tray collects the liquid and allows the distribution of the liquid on the contactor.

The standard on land distribution trays used in the absorption/stripping columns or even distillation columns generally consist of a plate which is intended to be a liquid collector and distributor. The liquid collector is also intended to be a gas distributor and a liquid conveyor. The operation of these distributor trays is generally by gravity. In this respect, a liquid seal, the height of which depends on the pressure loss through the tray and the liquid flow rate, generally forms on the tray to provide the hydraulic power necessary to the good operation of the liquid distributor which consumes a pressure energy in the flow.

Several types of gas/liquid distributor trays can be used, and can generally belong to three broad families:
gas chimney distributors: a liquid seal is established over all the section of the distributor tray, and supplies the contact (packed) bed via orifices uniformly distributed over the bottom of the tray. The gas is routed via chimneys (e.g.: US 2013/0277868A). FIG. 1 shows a conventional chimney distributor tray 1, provided with chimneys 2 for the passage of the gas, the chimneys being covered by “caps” 3 to avoid the passage of liquid into the gas chimneys (in a counter-current flow situation), and orifices 4 for the passage of liquid.
Liquid boxes distributors: a liquid seal is established over a set of boxes provided with supply orifices, and the gas is routed via the remaining space (e.g., U.S. Pat. No. 4,909,967A).
Liquid chimney distributors: these distributors operate according to the same principle as the gas chimney distributor. The difference is that the liquid is distributed via chimneys that can have several heights, thus making it possible to pass a wider range of flow rate than in the case of simple orifices in the tray bottom. The gas is, for its part, routed via chimneys that can have a cylindrical or parallelepipedal shape (e.g. U.S. Pat. No. 5,132,055A, U.S. Pat. No. 4,432,913).

One of the designs proposed by those skilled in the art consists in gathering the liquid at the central axis of the column, in the middle of the collector tray. The gathered and centralized liquid is discharged in a vertical conduit which links the liquid collector tray and the distribution system by one or more relatively long vertical conduits for the distributor system to remain filled with liquid (said to be “charged”), whatever the swell conditions encountered. The vertical conduit is dimensionned so that the variation of the liquid height due to a fault of horizontal alignment is significantly lower than the height of the liquid conduit supplying the distribution system (U.S. Pat. No. 8,118,284B2, US 2004/0020238 A1). In this case, the liquid distribution system can be formed by one or more sprinklers and the gas is routed by chimneys situated at the collector tray.

FIG. 2 shows an example of this type of distributor tray. The distributor tray 1 comprises chimneys 2 for the passage of the gas. The distributor tray 1 comprises a liquid distribution system, which comprises a vertical conduit 5 and a plurality of sprinklers 6 (horizontal pipes provided with orifices or nozzles). Other types of distribution systems have been developed, notably spray (by means of nozzles) or trough distribution systems.

For offshore applications, the movement of the swell rapidly degrades the distribution of the liquid and gas phases in the packed beds. This maldistribution is more or less significant depending on the type of packing retained, and depending on the periods and amplitudes associated with the movement of the swell. In any case, it affects the uniformity of the distribution of the liquid and of the gas in the contact beds with the creation of zones under-supplied with liquid (said to be “underloaded”), and zones over-supplied with liquid (said to be “overloaded”). These maldistributions of the liquid induce malgas distribution, with, once again, zones over-supplied and under-supplied with gas (relative to the average). The distribution of the zones depends on the conditions (movement undergone by the column, flow rates, contact technology, column size, etc.). The prior art shows that the loss of efficiency of the packed bed in the column is at its maximum when a zone over-supplied with gas encounters a zone under-supplied with absorbent liquid, which tends to degrade the efficiency of the columns concerned via the generation of marked concentration profiles.

In the gas treatment case, the hydrodynamic malgas distribution phase and of the liquid phase in a contact bed therefore leads to a more or less efficient absorption of the species to be eliminated in the gas phase via non-uniform velocity profiles, but also via non-uniform profiles of concentrations of chemical species (for example of H₂S, CO₂) in the two phases. In effect, the quantity of chemical species transferred between the gas and liquid phases depends partly on the composition of these phases and on the placing in contact thereof, which depends on the contactor and on the velocities of the gas and of the liquid. While the known distributor trays are supposed to redistribute the gas, they do not not remix thereof. They do not make it possible to make the chemical species concentration profile uniform over the section of the packed bed.

For a given design of gas treatment column, it seems favorable for the gas to have a concentration which is as uniform as possible over all the section to obtain the best efficiency and more easily meet the specifications in terms of residual H₂S and CO₂ concentrations at the column output. For on land applications, the liquid distribution systems and the heights of the beds are engineered to avoid excessively maldistributions of liquid and of gas and thus avoid notable concentration profiles. For offshore applications, the systems described do not sufficiently re-mix the gaseous phase.

The patent application WO 2014/070352A1 describes a system for mixing gas between two contact beds. The gas mixing system is formed by a plate which creates a gas passage section restriction between two contact beds so as to mix the latter before redistributing it. The gas mixing system described in this patent application does not provide any liquid distributor, and the liquid is collected at the periphery of the column before being introduced directly into the bed below, which renders the column sensitive to its inclination. Furthermore, the different gas mixing systems proposed in this document have a complex shape, the assembly of which can also be complex.

The patent U.S. Pat. No. 4,820,455 relates to a gas mixing induced by specific openings of the gas chimneys on the collector tray. The chimneys situated at the periphery send the gas to the center of the section and those situated at the center supply gas over 360°. This design can contribute to mixing the gas but this mixing remains partial in the case of maldistributions which extend over a large part of the section, notably if concentric non-uniformous gas distribution from the central axis of the column are envisaged. The invention proposed by this patent does not appear to lend itself to ensuring the re-mixing of the most peripheral zones with the gas circulating about the central axis of the column.

To overcome these drawbacks, the present invention relates to a column for exchanging heat and/or material between a gas and a liquid. The column comprises at least one collector tray, at least one packed bed, and mixing means for a gas flow. According to the invention, the mixing means for a gas flow are arranged below the collector tray and above the packing. Thus, the gas distribution is improved. Furthermore, the invention does not influence the distribution of the liquid arriving on the collector tray. Furthermore, mixing means for the gas flow are configured to distribute the gas flow over substantially all the section of the column, so as to increase the mixing of gas and to optimize the gas distribution over the upper packing.

The Device According to the Invention

The invention relates to a column for exchanging heat and/or material between a gas and a liquid, comprising at least one collector/distributor tray, and at least one packing for placing gas and liquid fluids in contact, said collector tray distributing said fluids over said packing, said column further comprising mixing means for a gas flow. Said mixing means for the flow of said gas are arranged below said collector tray and above said packing, and said mixing means for the flow of said gas are configured to distribute the gas flow over substantially all of the section of the column.

According to the invention, said mixing means are configured to drive the gas flow in a direction substantially parallel to the axis of said column.

According to an embodiment of the invention, said mixing means are configured to drive the gas flow in a substantially radial and/or ortho-radial direction relative to said column.

Advantageously, said mixing means are substantially parallel to said collector tray.

According to an embodiment, said mixing means for the flow of said gas comprise at least one plate deflecting at least a part of the current lines of said gas flow.

According to a variant embodiment, said plate is fixed relative to said collector tray.

Alternatively, said plate is rotationally mobile about an axis.

According to one aspect of the invention, said plate is substantially in the shape of a half-disk, a helix, a paddle, a blade or an inverted U.

Advantageously, said plate is mounted on a rod fixed to said collector tray.

According to an alternative, said collector tray comprises a distribution system comprising at least one supply conduit protruding below said collector tray, said plate being mounted on said supply conduit of said distribution system.

According to a variant, said mixing means for the gas flow comprise a number of plates arranged one below the other.

According to an embodiment, said mixing means for the flow of said gas generate a cyclonic movement of said gas flow.

Advantageously, said mixing means for the gas flow comprise at least one blade orientated toward the center of said column.

Alternatively, said mixing means for the gas flow comprise a deflector having a substantially helical shape of the worm screw type at the center of said column.

According to an embodiment, said collector tray comprises a distribution system comprising at least one conduit protruding below said collector tray, and in which said mixing means for the flow of said gas comprise a dry packing arranged around said conduit of said secondary distribution system.

According to an embodiment, said mixing means for the flow of said gas comprise means for restricting the gas passage section.

Preferably, said restricting means direct the flow of said gas to the periphery of said column.

As a variant, said restricting means comprise at least one chicane.

According to an embodiment, said mixing means for the gas are formed by a distribution system linked to said collector tray.

Advantageously, said distribution system comprises at least one conduit protruding below said collector tray, and a plurality of pipes linked to said conduit, said pipes being arranged substantially according to the generatrices of a cone, the axis of which corresponds substantially to the axis of said column so as to direct the gas.

Furthermore, said distribution system can comprise at least one conduit protruding below said tray, a gutter linked to the conduit, and a plurality of pipes linked to said gutter, said gutter comprising at least one orifice for the passage of the gas.

Furthermore, the invention relates to the use of a column according to one of the above features for a gas treatment, acid gas capture, distillation, dehydration or air separation method.

### BRIEF DESCRIPTION OF THE FIGURES

Other features and advantages of the method according to the invention will become apparent on reading the following description of nonlimiting exemplary embodiments with reference to the figures attached and described hereinbelow.

FIG. 1, already described, illustrates a collector/distributor tray according to the prior art.

FIG. 2, already described, illustrates a collector/distributor tray equipped with a secondary distribution system according to the prior art.

FIG. 3 illustrates a collector/distributor tray according to a first embodiment of the invention.

FIGS. 4a to 4c illustrate three collector/distributor trays according to three variants of the first embodiment of the invention.

FIG. 5 illustrates a collector/distributor tray according to a second embodiment of the invention.

FIG. 6 illustrates a collector/distributor tray according to a third embodiment of the invention.

FIG. 7 illustrates a section of a column according to a fourth embodiment of the invention.

FIG. 8 illustrates a collector tray according to a fifth embodiment of the invention.

FIGS. 9a and 9b illustrate two variants of a sixth embodiment of the invention.

FIG. 10 illustrates a mixing means for the gas flow according to a variant embodiment of the invention.

FIG. 11 illustrates a collector/distributor tray according to a seventh embodiment of the invention.

FIG. 12 illustrates a collector/distributor tray according to a variant of the seventh embodiment of the invention.

### DETAILED DESCRIPTION OF THE INVENTION

The present invention relates to a column for exchanging material and/or heat between a gas and a liquid. The column according to the invention is suitable for counter-current flows of the liquid and of the gas. However, the column according to the invention can also be suitable for co-current flows of the liquid and of the gas.

The column comprises at least one collector tray, and at least one packed bed. The collector tray makes it possible to form a liquid seal and allows the distribution of the liquid over the lower packing. Preferably, the column comprises at least two packed beds, the collector tray being situated between the two packed beds. The packing corresponds to a contactor and makes it possible to place the liquid and the gas in contact, in order to allow the exchanges of material and/or of heat between the fluids. According to the invention, the packing can be random packing or structured packing. The term packed bed is used to describe a packing section. Preferably, the exchange column comprises a plurality of collector trays and a plurality of packed beds.

According to the invention, the column further comprises mixing means for the gas flow. The mixing means for the gas flow are arranged between a liquid collector tray and a lower packed bed. The mixing means for the gas flow are situated below the liquid collector tray and above the packed bed immediately below. The notions of arrangement “below” and “above” correspond to the positioning of the different elements, when the column is in position of use, that is to say in a vertical position.

The mixing means for the gas flow are configured to distribute the gas flow over substantially all the section of the column. Thus, the gas mixing and the gas distribution over the upper packing are optimized compared to the prior art solutions, for which the gas flow is only redistributed by offering a minimum passage section which is based on the constricted fluid stream device known from the prior art. The constricted fluid stream phenomenon centralizes the fluid through a reduced orifice and then redistributes it in a passage section greater than the orifice. While this device makes it possible to ensure a good gas distribution velocities at the output of the orifice throughout the section of the column, the gas mixing however is not physically assured to the point of obtaining a uniformity of the gas distribution compositions over the section of the column, unlike the present invention which proposes devices suitable for and specific to the gas mixing.

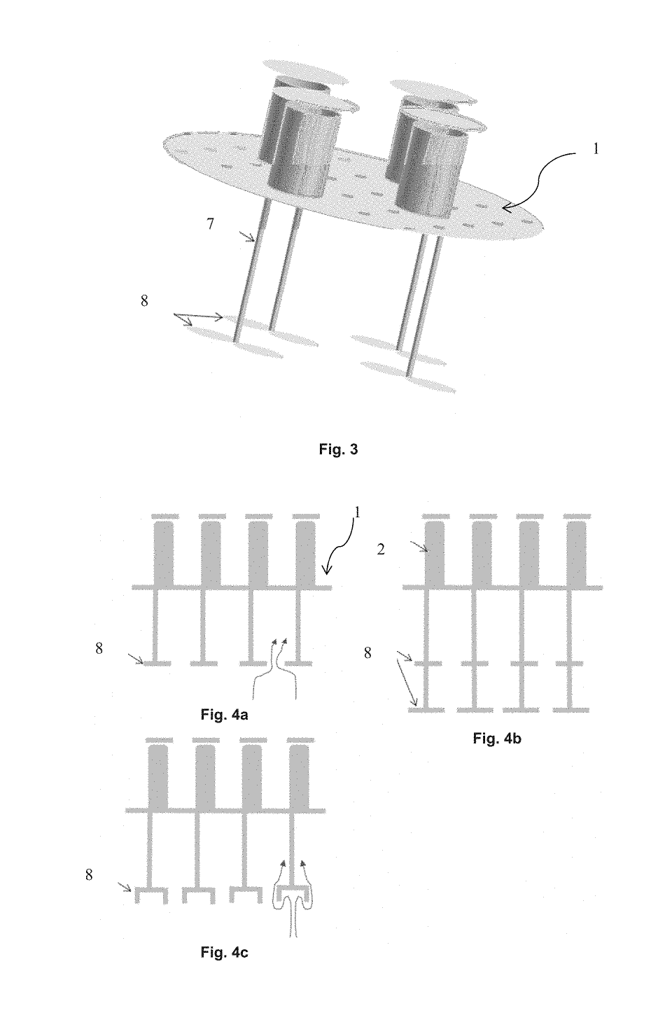

According to an embodiment of the invention, the mixing means for the gas flow can be arranged substantially parallel to the collector tray, that is to say that the main direction of the mixing means is substantially parallel to the collector tray. Thus, in a position of use of the column, the mixing means for the gas flow are substantially horizontal. Note however that the mixing means for the gas flow can have portions protruding in another direction, reference can for example be made to the embodiment of FIG. 4c which will be described in more detail hereinbelow in the description. “Substantially parallel” is used to denote a low angle with a plane parallel to the collector tray, that is to say less than 20°, and preferably less than 10°, and very preferably less than 5°. This quasi-parallel orientation of the mixing means for the gas flow allows for a simplicity of design and of assembly, notably compared to the mixing means for the gas flow which are specifically inclined relative to the collector tray. Furthermore, the horizontal alignment of the mixing means for the gas flow makes it possible to orient the gas flow in an axial, radial or ortho-radial, and non-inclined, direction of the column.

The mixing means for the gas flow make it possible to efficiently mix the gas at the output of a contact (packed) bed before introducing it into a second packed bed, in order to obtain a better distribution and a more uniform composition of the gas over all the section of the column, notably for the offshore applications. The mixing means for the gas flow can be combined with gas/liquid collector trays of the prior art which make it possible to distribute the gas and the liquid over all the section of the column. Physically, these mixing means for the gas flow generate the deflection of the gas stream lines, so as to create changes of trajectory which favor the mixing of a gas flow exhibiting a profile of concentration in one (or more) chemical compound(s) X. Thus, the gas concentration can be homogenized over all the section of the column. These mixing means for the gas flow can also amplify the turbulent nature of the flow which favors the mixing. The arrangement of the mixing means for the gas flow below the collector/distributor tray makes it possible to retain a good distribution of the liquid.

According to an embodiment of the invention, the mixing means for the gas flow can drive the gas flow in a substantially axial main direction (along the axis of the column, and a fortiori the axis of the collector tray and of any distribution means). The term “main direction of the flow” denotes the orientation of the gas flow within the column generated by the mixing means for the gas flow. When this main direction is substantially axial, the flow stream lines are mainly axial, and the gas flow is not angularly deflected relative to the axis of the column. Thus, the gas mixing is assured.

Alternatively, the mixing means for the gas flow can drive the gas flow in a main direction that is substantially radial and/or ortho-radial (relative to the column, and a fortiori relative to the axis of the collector tray and to optional distribution means). The term “main direction of the flow” denotes the orientation of the gas flow within the column generated by the mixing means for the gas flow. When this main direction is substantially radial or ortho-radial, the flow stream lines are mainly radial, and the gas flow is not angularly deflected relative to the horizontal plane. Thus, the gas mixing is assured. Furthermore, this design makes it possible to make the profile of the concentration(s) uniform relative to the radial direction.

The mixing means for the gas flow can take several forms: one or more fixed or mobile plate(s), dry packing, one or more blade(s), one or more restricting means, one or more chicane(s), adaptation of the shape of the distribution means etc.

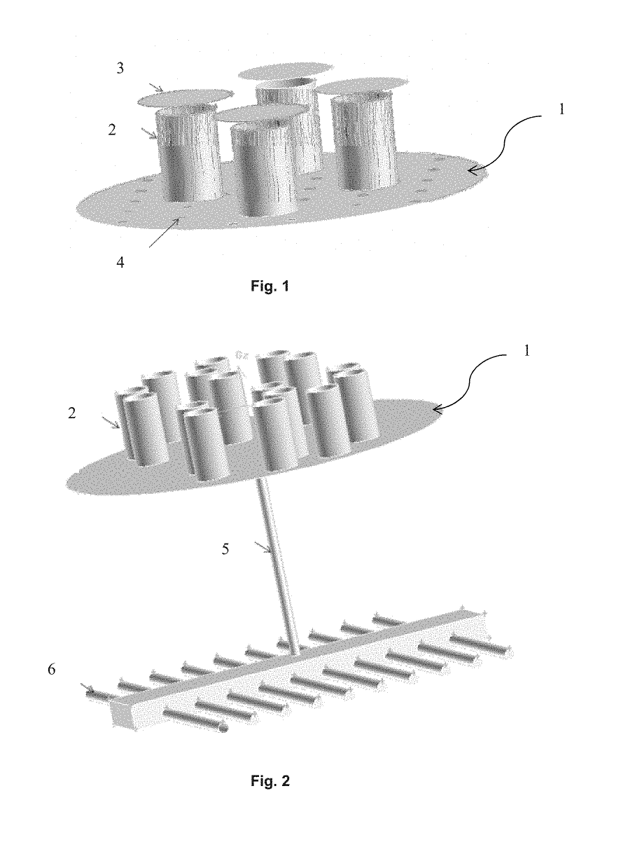

The collector tray can be produced according to different prior art designs. The collector/distributor tray can be produced notably according to the designs illustrated in FIGS. 1 and 2, with, for example:
chimneys 2 for the passage of the gas through the tray,
these chimneys 2 for the passage of gas through the tray can optionally comprise caps 3 to prevent the liquid from penetrating into the chimneys,
means for the passage of the liquid through the tray, these means can take the shape of orifices 4 and/or of chimneys for the passage of liquid (not illustrated), and
optionally, a distribution system, that can be formed for example by at least one vertical supply conduit (also called chimney) 5 protruding below the tray, this chimney being linked to a set of sprinklers 6 (which are substantially horizontal pipes provided with orifices and/or nozzles for the distribution of the liquid).

According to a first embodiment of the invention, the mixing means for the gas flow comprise at least one substantially horizontal plate (parallel to the collector tray). The plate makes it possible to deflect at least a part of the flow stream lines gas flow and to limit the gas maldistribution. Indeed, the plates form obstacles to the gas flow and enable this deflection. Furthermore, the plate is configured to distribute the gas flow substantially over the entire section of the column. The plate can be mounted on a rod fixed to the collector tray, removably screwed, supported by beams, etc. For this embodiment, the main direction of the gas flow is substantially axial.

The rod can be fixed to the collector tray for example by screwing, welding, through adhesive or any similar technique.

The plate can have substantially the shape of a half-disk, a helix, a portion of a helix, a paddle, an inverted U, or any similar form. Advantageously, the plate can have a surface representing up to 80% of the section of the column, so as to optimize the distribution of the gas flow.

The plate can be fixed relative to the rod, notably by screwing, welding, through adhesive or any similar technique. Alternatively, the plate can be mounted to be rotationally mobile relative to the rod, what makes it possible to increase the efficiency of the mixing. The rotation of the plate can be implemented by a driving mechanism, for example by a motor, or can be directly driven by the gas flow.

According to a variant of this embodiment, the collector tray can comprise a plurality of rods, onto each of which at least one plate can be mounted. This design enables a greater deflection of the gas flow stream lines, notably for the columns of larger diameter. This configuration also allows for a better distribution of the gas flow substantially over of the entire section of the column.

According to a particular design, a number of plates, for example two, can be mounted on a rod. Thus, it is possible to optimize the mixing of the gas flow.

For this embodiment, the collector/distributor tray may or may not comprise a liquid distribution system.

Advantageously, the plates can be metal plates.

FIG. 3 represents a nonlimiting variant of this first embodiment. The collector/distributor tray 1 is of the type illustrated in FIG. 1. It further comprises mixing means for the gas flow, these means are formed by four rods 7 (substantially at right angles to the collector tray) each supporting a fixed plate 8 (substantially parallel to the collector tray). The plates 8 are substantially in the shape of a paddle. Alternatively, the plates 8 can be rotationally mobile about the rods 7.

FIGS. 4a to 4c illustrate three nonlimiting variants of this first embodiment. FIG. 4a corresponds schematically to the variant embodiment of FIG. 3. The variant embodiment of FIG. 4b corresponds to the variant embodiment of FIG. 4a, for which the only modification consists in mounting, on each rod 7, two plates 8 substantially parallel to the collector tray 1. The variant of FIG. 4c differs from the variant of FIG. 4a by the fact that the plates 8 are substantially in the shape of an inverted U, which allows for a specific deflection of the flow stream lines and for an increase in turbulence. The main direction of the plate 8 in the shape of an inverted U is parallel to the collector tray 1. This deflection is schematically illustrated by arrows. The variants of FIGS. 4b and 4c can be combined.

According to another embodiment of the invention, the collector tray comprises a liquid distribution system. The distribution system can comprise at least one vertical supply conduit protruding below the collector tray. The conduit can be linked to a set of sprinklers (horizontal pipes provided with orifices and/or nozzles for the distribution of the liquid). For this embodiment, the mixing means for the gas flow can comprise at least one plate, substantially parallel to the collector/distributor tray. The plate makes it possible to deflect at least a part of the gas flow stream linesgas flow. Indeed, the plates form obstacles to the gas flow and enable for this deflection. Furthermore, the plate is configured to distribute the gas flow over substantially the entire section of the column. The plate is mounted on the vertical supply conduit of the distribution system. The plate can be fixed relative to the conduit. Alternatively, the plate can be constructed with a device which enables it to be rotationally mobile relative to the vertical supply conduit, what makes it possible to increase the efficiency of the mixing. For this embodiment, the main direction of the gas flow is substantially axial.

According to a variant of this second embodiment, the plate can be substantially in the shape of a blade. Advantageously, the mixing means for the gas flow can comprise several blades mounted on the vertical supply conduit of the distribution system.

According to a variant of this embodiment, the distribution system can comprise several supply conduits protruding below the collector tray, on each of which at least one plate can be mounted. This design allows for a greater deflection of the gas flow stream current lines, notably for the columns of larger diameter.

Advantageously, the plates can be metal plates.

This embodiment is not illustrated, but can correspond to an arrangement of the plates 8 illustrated in FIGS. 3, 4a to 4c, on one or more conduits 5 of a distribution system as illustrated in FIG. 2, instead of a rod.

According to a second embodiment of the invention, the mixing means for the gas flow comprise at least one rotary plate, preferably a plurality of rotary plates. The rotation of the plate can be implemented by a driving mechanism, for example by a motor, or can be directly driven by the gas flow. The rotary plates can be substantially parallel to the collector tray. This embodiment can be combined with the embodiments previously described. The rotation of the plates allows for a gas flow distribution and the mixing thereof until a uniform composition is obtained over the entire section of the column.

According to one design, the plates can have the shape of blades mounted to be rotationally mobile about a rod fixed to the collector/distributor tray or a supply conduit of a distribution system.

Advantageously, the plates can be metal.

FIG. 5 illustrates a nonlimiting variant of this second embodiment of the invention. The collector/distributor tray 1 comprises a rod 7, on which a set comprising four blades 8 is mounted to be rotationally mobile.

According to a third embodiment of the invention, the mixing means for the gas flow make it possible to form a cyclonic movement of the gas flow in the column, which allows for an efficient mixing of the gas flow. The cyclonic movement is virtually propagated over the entire section of the column, thus ensuring the distribution of the gas flow and the mixing thereof until a uniform composition is obtained.

According to a design allowing for the cyclonic movement of the gas flow, the mixing means for the gas flow can be similar to a static “turbine” which generates a cyclonic movement of the gas. Thus, the mixing means for the gas flow can be formed by “blades”, which can be profiled and inclined relative to the vertical, and weakly inclined relative to the horizontal, and capable of covering the entire gas passage section. These blades can be mounted on the shell of the column in the empty space below the collector/distributor tray and above the packing.

According to an alternative, the cyclonic movement of the gas can also be generated by a system of helical type relying on a “worm screw” mounted on a rod or on a conduit of a secondary distribution system. The “worm screw” system comprises a threading having a low angle relative to the collector tray. The gas is disturbed in its raising by the device so as to increase the mixing and the distribution uniformly over the entire section of the column.

The blades and the “worm screw” system can be metal.

This embodiment is suitable for collector trays with and without liquid distribution system.

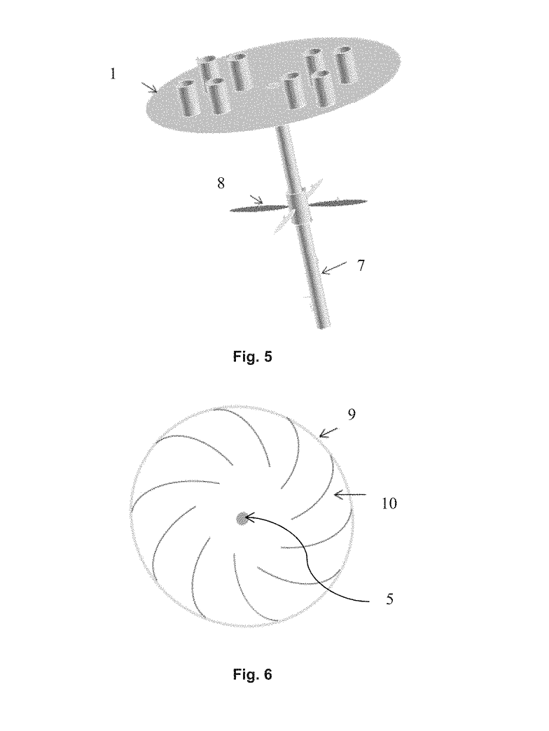

FIG. 6 illustrates a nonlimiting variant of this third embodiment. This figure is a cross-sectional view of a section of the column at a level lying between the packing and the collector/distributor tray. At this level, the collector/distributor tray can comprise a supply conduit 5 of a distribution system. According to this variant, the column 9 comprises a set of blades 10 that are profiled and inclined relative to the vertical. The blades 10 are distributed over all the periphery of the column 9. The blades 10 generate a cyclonic movement of the gas.

FIG. 10 schematically and in a nonlimiting manner illustrates an example of worm screw 21, fixed around a rod 7. The rod 7 is fixed to a collector tray (not illustrated). The angle θ of the worm screw relative to the horizontal is low, that is to say less than 20°.

According to a fourth embodiment, the collector tray comprises a distribution system. The distribution system comprises at least one vertical supply conduit protruding below the collector/distributor tray. The conduit can be linked to a set of sprinklers. For this embodiment, the mixing means for the gas flow comprise a packing, called dry packing, because this packing is passed through only by the gas and not by the liquid. The dry packing allows for a mixing of the gas flow, by virtue of the dispersive properties of the flows in the packing, whether it is a random packing or a structured packing. The packed bed can be substantially parallel to the collector tray. For this embodiment, the main direction of the gas flow is substantially axial. Furthermore, the dry packing occupies substantially the entire section of the column, which ensures the distribution of the gas flow over this section and the mixing thereof until a uniform composition is obtained.

This fourth embodiment is particularly suitable for offshore columns, for which the gas and the liquid are not mixed in the space between two contact beds (between two packing sections). Furthermore, the fourth embodiment has a reduced bulk, and makes it possible to occupy the smaller spaces left available between the collection zone and the existing distributors.

In the case of an onshore distributor, a packing having a significant capacity can, preferably, be installed as dry packing, in order to avoid blocking states.

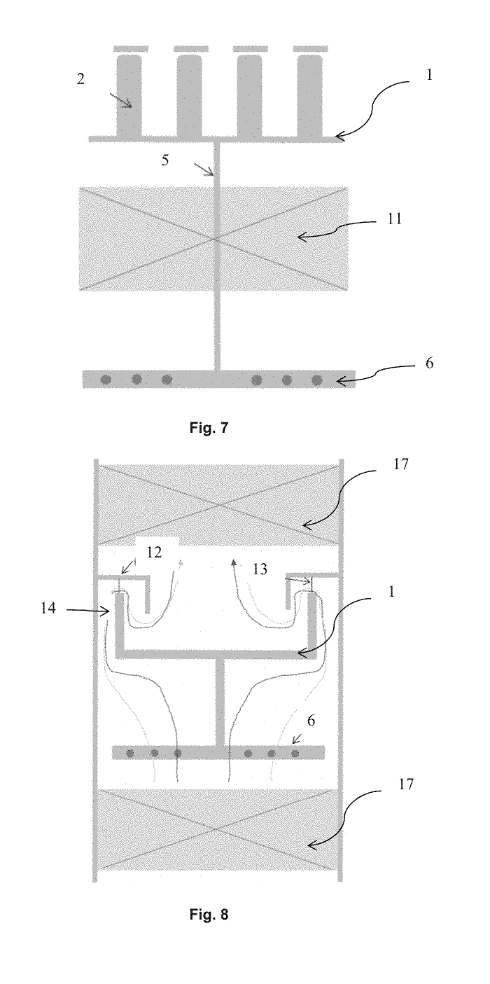

FIG. 7 illustrates a nonlimiting variant of this fourth embodiment. The collector tray 1 (which conventionally comprises chimneys 2 for the passage of the gas), comprises a distribution system comprising a vertical supply conduit 5 and sprinklers 6. At the supply conduit 5, the mixing means for the gas flow comprise a dry packing 11. Only the gas passes through the dry packing 11. Indeed, the liquid does not pass through the dry packing 11, because it passes directly from the collector/distributor tray 1 to the sprinklers 6.

According to a fifth embodiment of the invention, the mixing means for the gas flow comprise means for restricting the gas passage section. The restricting means direct the gas flow to the periphery of the column. Thus, the gas is oriented at a precise point, and is therefore efficiently mixed. The restricting means occupy substantially the entire section of the column. Thus, the restricting means allow for a distribution of the gas flow over this section. The restricting means generate a substantially radial flow (main radial direction of the flow) at the periphery of the column.

A variant consists in the collector tray being free of chimneys for the passage of gas. The gas cannot pass over the section occupied by the liquid collector, and passes over an annular section at the periphery of the column left open.

The means for restricting the gas passage section can be metal.

FIG. 8 illustrates, in a nonlimiting manner, this embodiment variant. This figure shows a mounting of the collector tray 1 between two contact beds 17. The collector tray 1 does not comprise any chimney for the passage of the gas. The gas circulating in the upward direction is routed through the annular section 14 at the periphery of the column then is redirected over the entire section before entering into the upper packed bed. This redirection is assured by a profiled plate (or crown ring) 12 having an annular shape interdependent with the shell of the column. The deflection of the gas stream lines favoring the mixing is schematically represented in this figure. In this configuration, the collector/distributor tray can no longer be mounted on a flange at the shell of the column. One possible fixing mode consists in suspending this latter from an annular plate 12 using rods 13. For the variant illustrated, the collector tray 1 comprises a conduit linked to a set of sprinklers 6.

According to a sixth embodiment of the invention, the mixing means for the gas flow comprise means for restricting the gas passage section. The restricting means form at least one chicane, around which the gas passes. Thus, the gas, being oriented at a precise point, is efficiently mixed. Preferably, the restricting means form several chicanes. The chicanes determine a preferred passage for the gas. The chicanes can be formed by flat plates substantially parallel to the collector tray. Alternatively, the chicanes can be formed by plates of substantially chevron form. The flat plates can be mounted on a rod or on a conduit of a secondary distribution system. The restricting means occupy substantially the entire section of the column. Thus, the restricting means allow for a distribution of the gas flow over this section. The restricting means generate a main flow direction that is substantially radial.

According to a variant of this embodiment, the gas can pass on both sides of the chicanes. Alternatively, the gas can pass on only one side of the chicanes.

The passages for the gas can have different dimensions so as to create velocity gradients over the section of the column and favor the gas mixing.

Furthermore, the chicanes can also be provided with orifices/openings for the passage of the gas.

This embodiment can be produced with a collector tray with or without distribution system.

Advantageously, the means for restricting the gas passage section can be metal.

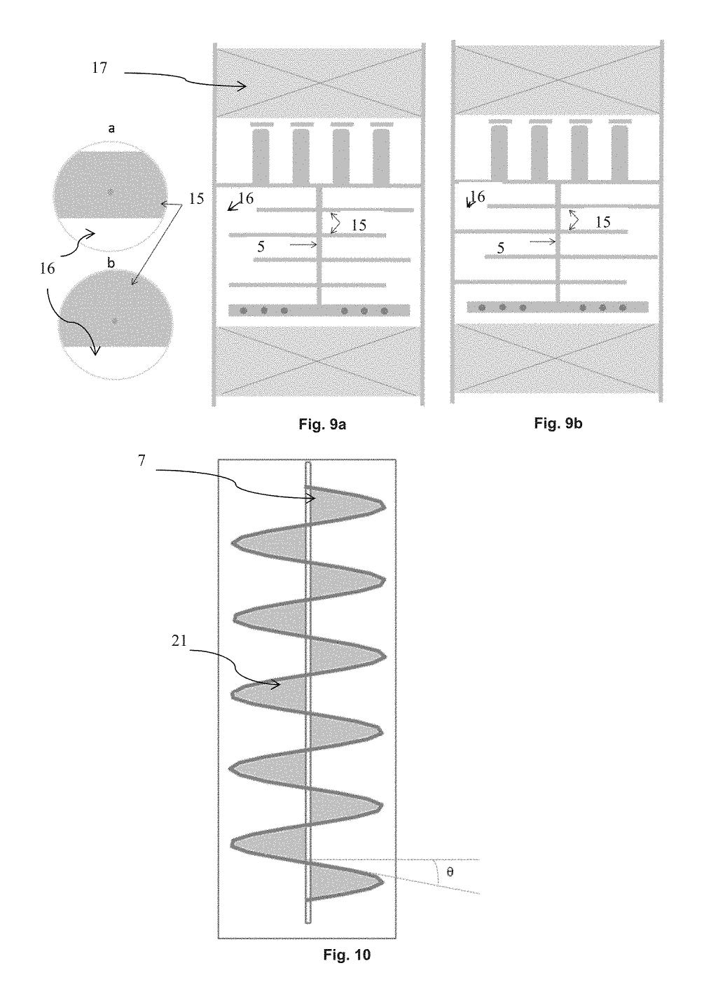

FIGS. 9a and 9b illustrate two nonlimiting variants of this sixth embodiment. The left-hand part of the figure illustrates, respectively for the designs of FIGS. 9a and 9b, a section of the column at flat plate of a chicane.

The variant of FIG. 9a comprises a plurality of flat plates 15 forming chicanes. The flat plates 15 are substantially parallel to the collector tray 1. The chicanes leave passages 16 for the passage of the gas. The flat plates 15 are mounted on a conduit 5 of a secondary distribution system. The flat plates are not in contact with the walls of the column, which allows for a passage of the gas on both sides of the flat plates 15.

The variant of FIG. 9b comprises a plurality of flat plates 15 forming chicanes. The flat plates 15 are substantially parallel to the collector tray 1. The chicanes leave passages 16 for the passage of the gas. The flat plates are mounted on a conduit 5 of a secondary distribution system. The flat plates are in contact over a portion of the flat plates with the walls of the column, which allows a passage of the gas on only one side of the flat plates 15.

According to a seventh embodiment of the invention, the mixing means for the gas can be formed by a distribution system, situated under the collector tray. For this embodiment, the shape of the distribution system can make it possible to orient the gas flow, and therefore mix the gas. As a variant, the distribution system can comprise at least one orifice for the passage of the gas, so as to orient it, and therefore mix it. Alternatively, these two variants (form and orifice) can be combined so as to increase the mixing. The distributor occupies substantially the entire section of the column, thus allowing a distribution of the gas flow over this section. For this embodiment, the gas flow has a main axial direction of flow.

The distribution system can be based on the example of FIG. 2, and comprise at least one vertical conduit and a plurality of substantially horizontal pipes. The pipes ensure the distribution of the liquid over the lower packing.

According to a first variant, for which the shape of the distribution system ensures the gas mixing, the pipes are inclined and substantially oriented according to generatrices of a cone, the axis of which coincides with the axis of the column. This arrangement of the pipes notably makes it possible to favor the turbulent gas flow, thus ensuring a gas mixing between the packing and the collector tray.

According to a second variant, for which the mixing is allowed by at least one orifice, at least one orifice can be provided in a horizontal gutter. The orifice allows for the passage of the gas. Furthermore, the orientation of the orifice makes it possible to direct the gas in a desired direction, which makes it possible to optimize the mixing. Advantageously, the orifice is inclined relative to the horizontal direction. According to a first design of this variant, the orifice is inclined from the center toward the periphery of the column. Alternatively, the orifice can be inclined from the periphery toward the center of the column.

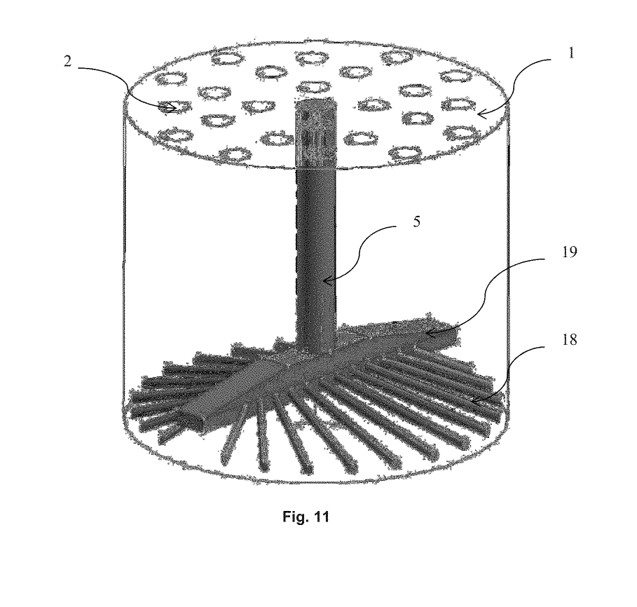

FIG. 11 illustrates a nonlimiting example of the first variant of this seventh embodiment. In this figure, the chimneys 2 for the passage of the gas are schematically represented by circles on the collector tray 1. For this example, the collector tray 1 comprises a distribution system protruding below. The distribution system comprises a substantially vertical conduit 5. A plurality of pipes 18 is linked to the vertical conduit, for example by means of a substantially horizontal closed gutter 19. The pipes 18 are inclined relative to the horizontal direction. Furthermore, the pipes 18 are arranged substantially according to generatrices of a cone, the axis of which coincides with the axis of the column, and with the axis of the conduit 5 in this example.

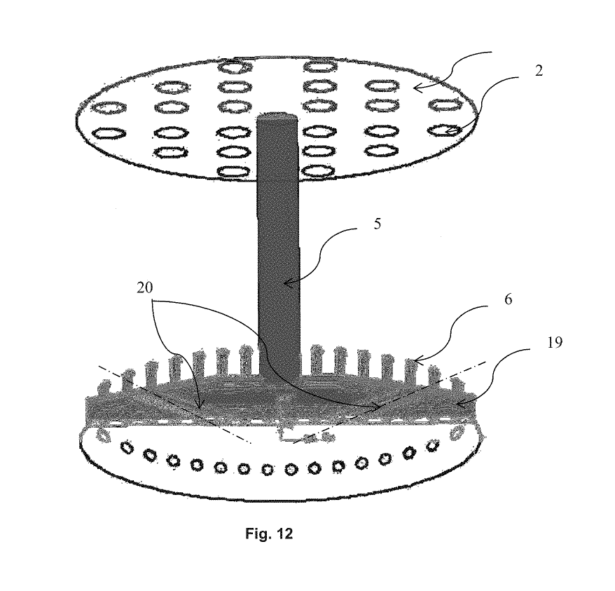

FIG. 12 illustrates a nonlimiting example of the second variant of this seventh embodiment. In this figure, the chimneys 2 for the passage of the gas are schematically represented by circles on the collector tray 1. For this example, the collector tray 1 comprises a distribution system protruding below. The distribution system comprises a substantially vertical conduit 5. A plurality of pipes 6 is linked to the vertical conduit, by means of a closed substantially horizontal gutter 19. The pipes 6 in the foreground are not fully represented, they are schematically represented by circles. The pipes 6 are substantially horizontal. Furthermore, the pipes 6 are substantially at right angles to the gutter 19. The closed gutter 19 comprises at least one, here two, orifices 20, allowing the passage of the gas from under the closed gutter 19 over the closed gutter 19. The orifices 20 are inclined relative to the vertical direction. The orifices 20 are oriented from the center toward the periphery of the column.

As a variant, the arrangement of pipes 6 of FIG. 12 can be replaced by the arrangement of pipes 18 of FIG. 11, so as to increase the redirecting of the gas and therefore the mixing thereof between the packing and the collector tray.

The column according to the invention is advantageously an amine-based washing column but is suitable for any type of solvents.

The column according to the invention can be used in gas treatment, CO₂ capture, distillation, dehydration or air separation methods. The column according to the invention can be used for applications offshore (at sea) or on land.

Furthermore, the invention relates to an offshore floating barge, notably of the FPSO or FLNG type, notably for the production and treatment of hydrocarbons. The barge comprises a column for exchanging material and/or heat between a gas and a liquid as described above. The column can form part of a gas treatment and/or CO₂ capture unit for cleaning gaseous products (or fumes). On the floating barges, distillation columns and/or dehydration columns using this device can also be installed.

1) A column for exchanging heat and/or material between a gas and a liquid, comprising at least one collector/distributor tray (1), and at least one packing (17) for placing gas and liquid fluids in contact, said collector tray (1) distributing said fluids over said packing (17), said column further comprising mixing means (8, 10, 11, 14, 15, 18, 19) for a gas flow, characterized in that said mixing means for the flow of said gas are arranged below said collector tray (1) and above said packing (17), and in that said mixing means for the flow of said gas are configured to distribute the gas flow over substantially all of the section of the column.

2) The column as claimed in claim 1, in which said mixing means are configured to drive the gas flow in a direction substantially parallel to the axis of said column.

3) The column as claimed in claim 1, in which said mixing means are configured to drive the gas flow in a substantially radial and/or ortho-radial direction relative to said column.

4) The column as claimed in claim 1, in which said mixing means are substantially parallel to said collector tray (1).

5) The column as claimed in claim 1, in which said mixing means for the flow of said gas comprise at least one plate (8) deflecting at least a part of the current lines of said gas flow.

6) The column as claimed in claim 5, in which said plate (8) is fixed relative to said collector tray (1).

7) The column as claimed in claim 5, in which said plate (8) is rotationally mobile about an axis.

8) The column as claimed in, claim 5, in which said plate (8) is substantially in the shape of a half-disk, a helix, a paddle, a blade or an inverted U.

9) The column as claimed in claim 5, in which said plate (8) is mounted on a rod (7) fixed to said collector tray (1).

10) The column as claimed in claim 5, in which said collector tray (1) comprises a distribution system comprising at least one supply conduit (5) protruding below said collector tray (1), said plate (8) being mounted on said supply conduit (5) of said distribution system.

11) The column as claimed in claim 5, in which said mixing means for the gas flow comprise a number of plates (8) arranged one below the other.

12) The column as claimed in claim 3, in which said mixing means for the flow of said gas generate a cyclonic movement of said gas flow.

13) The column as claimed in claim 12, in which said mixing means for the gas flow comprise at least one blade (10) oriented toward the center of said column.

14) The column as claimed in claim 12, in which said mixing means for the gas flow comprise a deflector having a substantially helical shape of the worm screw type at the center of said column.

15) The column as claimed in claim 1, in which said collector tray comprises a distribution system comprising at least one conduit (5) protruding below said collector tray (1), and in which said mixing means for the flow of said gas comprise a dry packing (11) arranged around said conduit (5) of said secondary distribution system.

16) The column as claimed in claim 1, in which said mixing means for the flow of said gas comprise means (14, 15) for restricting the gas passage section.

17) The column as claimed in claim 16, in which said restricting means (14) direct the flow of said gas to the periphery of said column.

18) The column as claimed in claim 16, in which said restricting means comprise at least one chicane (15).

19) The column as claimed in claim 1, in which said mixing means for the gas are formed by a distribution system linked to said collector tray (1).

20) The column as claimed in claim 19, in which said distribution system comprises at least one conduit (5) protruding below said collector tray, and a plurality of pipes (18) linked to said conduit (5), said pipes (18) being arranged substantially according to the generatrices of a cone, the axis of which corresponds substantially to the axis of said column so as to direct the gas.

21) The column as claimed in claim 19, in which said distribution system comprises at least one conduit (5) protruding below said tray, a gutter (19) linked to the conduit, and a plurality of pipes (6) linked to said gutter (19), said gutter (19) comprising at least one orifice (20) for the passage of the gas.

22) A method of gas treatment, acid gas capture, distillation, dehydration or air separation, comprising subjecting a feed to effective condition in a column according to claim 1.
